(19) United States
(12) Patent Application Publication
(10) Pub. No.: US 2024/0202881 A1
(43) Pub. Date: Jun. 20, 2024

(54) IMAGE PROCESSING METHOD AND IMAGE PROCESSING DEVICE

(71) Applicant: MEDIATEK INC., Hsinchu City (TW)

(72) Inventors: Yuan-Chen CHENG, Hsinchu City (TW); Hao-Tien CHIANG, Hsinchu City (TW); Tai-Hsiang HUANG, Hsinchu City (TW); Ying-Jui CHEN, Hsinchu City (TW); Chi-Cheng JU, Hsinchu City (TW)

(21) Appl. No.: 18/541,137

(22) Filed: Dec. 15, 2023

Related U.S. Application Data
(60) Provisional application No. 63/387,710, filed on Dec. 16, 2022.

(51) Int. Cl. G06T 5/50; G06T 3/40; G06T 5/70; G06T 7/246

(52) U.S. Cl. CPC G06T 5/50; G06T 3/40; G06T 5/70; G06T 7/248; G06T 2207/10016; G06T 2207/20016; G06T 2207/20221

(57) ABSTRACT

An image processing method is provided. The method includes a first MCNR stage and a second MCNR stage. The first MCNR stage includes blending the current frame with either a cached image or a long-term reference image to obtain a fused image. The cached image is loaded from the buffer unit, and the long-term reference image is derived from the static region of each input frame in a sequence of input frames. The second MCNR stage includes blending the fused image with the other of the cached image or the long-term reference image to obtain an output image.

### CROSS REFERENCE TO RELATED APPLICATIONS

This application claims the benefit of U.S. Provisional Application No. 63/387,710, filed Dec. 16, 2022, the entirety of which is incorporated by reference herein.

### BACKGROUND OF THE INVENTION

### Field of the Invention

The present disclosure relates generally to image processing, and it relates in particular to motion compensated noise reduction (MCNR).

### Description of the Related Art

During the process of recording video or real-time previewing using a camera, it is common for noises to be produced by the camera's sensor or image signal processor (ISP). The noises are undesirable because they lead to flickering in each frame of the video. Moreover, when a moving object passes by, sudden noise may appear, causing discontinuity in comparison to other regions of the video.

A common solution to address this issue is motion compensated noise reduction (MCNR). Conventional MCNR typically blends the current input frame with its previous frame using image blending algorithms such as alpha blending. However, such conventional MCNR approaches may struggle to effectively differentiate between noise and actual motion in dynamic scenes, leading to suboptimal noise reduction outcomes. Moreover, static regions within frames may not be adequately distinguished from noise. In such cases, indiscriminate blending can result in the unintentional retention of noise in regions that should remain static. Therefore, there is a need for a method and image processing device to improve the quality of recorded videos and provide a more visually pleasing experience for the viewer.

### BRIEF SUMMARY OF THE INVENTION

An embodiment of the present disclosure provides an image processing method. The method includes the first MCNR stage and the second MCNR stage. The first MCNR stage includes blending a current frame with either a cached image or a long-term reference image to obtain a fused image. The cached image is loaded from a buffer unit, and the long-term reference image is derived from a static region of each input frame in a sequence of input frames. The second MCNR stage includes blending the fused image with the other of the cached image or the long-term reference image to obtain an output image.

In an embodiment, the method further includes an LTR-generation process for deriving the long-term reference image. The LTR-generation process includes the step of estimating the motion information of multiple input frames in the sequence of input frames, the step of identifying the static region in each of the input frames based on the motion information, and the step of blending the input frames based on their respective static regions to obtain the long-term reference image. In a further embodiment, the LTR-generation process further includes generating a confidence map that corresponds to the long-term reference image based on the motion information of the sequence of input frames. Additionally, the first MCNR stage further includes determining a set of weights for blending each pixel of the current frame with the corresponding pixel of the long-term reference image based on the confidence map.

In an embodiment, the first MCNR stage further includes blending the current frame with the long-term reference image to obtain the fused image. Additionally, the second MCNR stage further includes blending the fused image with the cached image to obtain the output image. Moreover, the obtained output image is stored in the buffer unit as the cached image.

In an embodiment, the method further includes the step of resizing a level-0 current frame to obtain a level-1 current frame, and resizing a level-0 long-term reference image to obtain a level-1 long-term reference image. The method further includes a level-1 first MCNR stage that involves blending the level-1 current frame with the level-1 long-term reference image to obtain a level-1 fused image. The method further includes a level-0 first MCNR stage that involves deriving a level-0 fused image through blending the level-0 current frame with the level-0 long-term reference image and performing a reconstruction process based on the level-1 fused image. The method further includes the step of resizing the level-0 fused image. The method further includes a level-1 second MCNR stage that involves blending the resized level-0 fused image with a level-1 cached image to obtain a level-1 output image. The method further includes a level-0 second MCNR stage that involves deriving a level-0 output image through blending the level-0 fused image with the level-0 cached image and performing the reconstruction process based on the level-1 output image. In a further embodiment, the level-1 output image is obtained either by resizing the level-0 cached image or by accessing the level-1 output image from the buffer unit.

In another embodiment, the method further includes the step of resizing a level-0 current frame to obtain a level-1 current frame, and resizing a level-0 long-term reference image to obtain a level-1 long-term reference image. The method further includes a level-1 first MCNR stage that involves blending the level-1 current frame with the level-1 long-term reference image to obtain a level-1 fused image. The method further includes a level-0 first MCNR stage that involves deriving a level-0 fused image through blending the level-0 current frame with the level-0 long-term reference image and performing a reconstruction process based on the level-1 fused image. The method further includes a level-1 second MCNR stage that involves blending the level-1 fused image with a level-1 cached image to obtain a level-1 output image. The method further includes a level-0 second MCNR stage that involves deriving a level-0 output image through blending the level-0 fused image with the level-0 cached image and performing the reconstruction process based on the level-1 output image.

In another embodiment, the method further includes the step of resizing a level-0 current frame to obtain a level-1 current frame, and resizing a level-0 long-term reference image to obtain a level-1 long-term reference image. The method further includes a level-1 first MCNR stage that involves blending the level-1 current frame with the level-1 long-term reference image to obtain a level-1 fused image. The method further includes a level-1 second MCNR stage that involves blending the level-1 fused image with a level-1 cached image to obtain a level-1 output image. The method further includes a level-0 first MCNR stage that involves deriving a level-0 output image through blending the level-0 current frame with the level-0 long-term reference image and performing a reconstruction process based on the level-1 output image. In a further embodiment, the method further includes the step resizing a level-0 current frame to obtain a level-2 current frame, and resizing a level-0 long-term reference image to obtain a level-2 long-term reference image. The method further includes a level-2 first MCNR stage that involves blending the level-2 current frame with the level-2 long-term reference image to obtain a level-2 fused image. The method further includes the step of resizing the level-1 fused image. The method further includes a level-2 second MCNR stage that involves blending the resized level-1 fused image with a level-2 cached image to obtain a level-2 output image.

In another embodiment, the method further includes the step of resizing a level-0 current frame to obtain a level-1 current frame, and resizing a level-0 long-term reference image to obtain a level-1 long-term reference image. The method further includes a level-1 first MCNR stage that involves blending the level-1 current frame with the level-1 long-term reference image to obtain a level-1 fused image. The method further includes a level-1 second MCNR stage that involves blending the level-1 fused image with a level-1 cached image to obtain a level-1 output image. The method further includes a level-0 first MCNR stage that involves deriving a level-0 output image through blending the level-0 current frame with the level-0 long-term reference image and performing a reconstruction process based on the level-1 output image. In a further embodiment, the method further includes the step of resizing a level-0 current frame to obtain a level-2 current frame, and resizing a level-0 long-term reference image to obtain a level-2 long-term reference image. The method further includes a level-2 first MCNR stage that involves blending the level-2 current frame with the level-2 long-term reference image to obtain a level-2 fused image. The method further includes the step of resizing the level-1 fused image. The method further includes a level-2 second MCNR stage that involves blending the resized level-1 fused image with a level-2 cached image to obtain a level-2 output image. In an alternative embodiment, the method further includes the step of resizing a level-0 current frame to obtain a level-2 current frame, and resizing a level-0 long-term reference image to obtain a level-2 long-term reference image. The method further includes a level-2 first MCNR stage that involves blending the level-2 current frame with the level-2 long-term reference image to obtain a level-2 fused image. The method further includes a level-2 second MCNR stage that involves blending the level-2 fused image with a level-2 cached image to obtain a level-2 output image.

In an embodiment, the first MCNR stage further includes blending the current frame with the cached image to obtain the fused image. The second MCNR stage further includes blending the fused image with the long-term reference image to obtain the output image. Additionally, either the obtained output image or the fused image is stored in the buffer unit as the cached image.

In an embodiment, the first MCNR stage and the second MCNR stage are applied to the image pyramid architecture.

An embodiment of the present disclosure provides an image processing device. The image processing device includes a buffer unit, the first MCNR unit, and the second MCNR unit. The buffer unit is for storing a cached image. The first MCNR unit is configured to blend a current frame with either the cached image or a long-term reference image to obtain a fused image. The cached image is loaded from the buffer unit, and the long-term reference image is derived from a static region of each input frame in a sequence of input frames. The second MCNR unit is configured to blend the fused image with the other of the cached image or the long-term reference image to obtain an output image.

In an embodiment, the image processing device further includes an LTR-generation unit. The LTR-generation unit is configured to estimate motion information of multiple input frames in the sequence of input frames, identify the static region in each of the input frames based on the motion information, and blend the input frames based on their respective static regions to obtain the long-term reference image. In a further embodiment, the LTR-generation unit is further configured to generate a confidence map that corresponds to the long-term reference image based on the motion information of the sequence of input frames. Additionally, the first MCNR unit is further configured to determine a set of weights for blending each pixel of the current frame with the corresponding pixel of the long-term reference image based on the confidence map.

In an embodiment, the first MCNR unit is further configured to blend the current frame with the long-term reference image to obtain the fused image. Additionally, the second MCNR unit is further configured to blend the fused image with the cached image to obtain the output image. Moreover, the obtained output image is stored in the buffer unit as the cached image.

In an embodiment, the image processing device further includes a resizing unit. The resizing unit is configured to resize a level-0 current frame to obtain a level-1 current frame, and resize a level-0 long-term reference image to obtain a level-1 long-term reference image. Additionally, the first MCNR unit is further configured to blend the level-1 current frame with the level-1 long-term reference image to obtain a level-1 fused image. The first MCNR unit is further configured to derive a level-0 fused image through blending the level-0 current frame with the level-0 long-term reference image and performing a reconstruction process based on the level-1 fused image. Moreover, the second MCNR unit is further configured to blend the level-1 fused image with a level-1 cached image to obtain a level-1 output image. The second MCNR unit is further configured to derive a level-0 output image through blending the level-0 fused image with the level-0 cached image and performing the reconstruction process based on the level-1 output image.

In another embodiment, the image processing device further includes the resizing unit. The resizing unit is configured to resize a level-0 current frame to obtain a level-1 current frame, and resize a level-0 long-term reference image to obtain a level-1 long-term reference image. Additionally, the first MCNR unit is further configured to blend the level-1 current frame with the level-1 long-term reference image to obtain a level-1 fused image. Moreover, the second MCNR unit is further configured to blend the level-1 fused image with a level-1 cached image to obtain a level-1 output image. The first MCNR unit is further configured to derive a level-0 output image through blending the level-0 current frame with the level-0 long-term reference image and performing a reconstruction process based on the level-1 output image.

In an embodiment, the first MCNR unit is further configured to blend the current frame with the cached image to obtain the fused image. Additionally, the second MCNR unit is further configured to blend the fused image with the long-term reference image to obtain the output image. Moreover, either the obtained output image or the fused image is stored in the buffer unit as the cached image.

In an embodiment, the first MCNR unit and the second MCNR unit are applied to an image pyramid architecture.

### BRIEF DESCRIPTION OF THE DRAWINGS

The present disclosure can be more fully understood by reading the subsequent detailed description and examples with references made to the accompanying drawings. Additionally, it should be appreciated that in the flow diagram of the present disclosure, the order of execution for each blocks can be changed, and/or some of the blocks can be changed, eliminated, or combined.

FIG. 1 is a schematic architecture diagram illustrating an image processing device, according to an embodiment of the present disclosure.

FIG. 2 is a flow diagram illustrating an image processing method, according to an embodiment of the present disclosure.

FIG. 3 is a flow diagram illustrating the LTR-generation process, according to an embodiment of the present disclosure.

FIG. 4 is a schematic architecture diagram illustrating an image processing device, according to an embodiment of the present disclosure.

FIG. 5 is a schematic architecture diagram illustrating an image processing device, according to another embodiment of the present disclosure.

FIG. 6 is a schematic architecture diagram illustrating an image processing device, according to another embodiment of the present disclosure.

FIG. 7 is a schematic diagram illustrating the generation of an image pyramid, according to an embodiment of the present disclosure.

FIG. 8A is a schematic diagram illustrating an image processing method, according to an embodiment of the present disclosure.

FIG. 8B is a schematic diagram illustrating an image processing method, according to another embodiment of the present disclosure.

FIG. 9 is a schematic diagram illustrating an image processing method, according to another embodiment of the present disclosure.

FIG. 10A is a schematic diagram illustrating an image processing method, according to another embodiment of the present disclosure.

FIG. 10B is a schematic diagram illustrating an image processing method, according to another embodiment of the present disclosure.

FIG. 11A is a schematic diagram illustrating an image processing method, according to another embodiment of the present disclosure.

FIG. 11B is a schematic diagram illustrating an image processing method, according to another embodiment of the present disclosure.

FIG. 12 is a schematic diagram illustrating an image processing method, according to another embodiment of the present disclosure.

FIG. 13A is a schematic diagram illustrating an image processing method, according to another embodiment of the present disclosure.

FIG. 13B is a schematic diagram illustrating an image processing method, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

Ordinal terms used in the claims, such as “first,” “second,” or “third,” are only for convenience of explanation, and do not imply any precedence relation between one another.

The description for the embodiments the image processing method is also applicable to the embodiments of the image processing device, and vice versa.

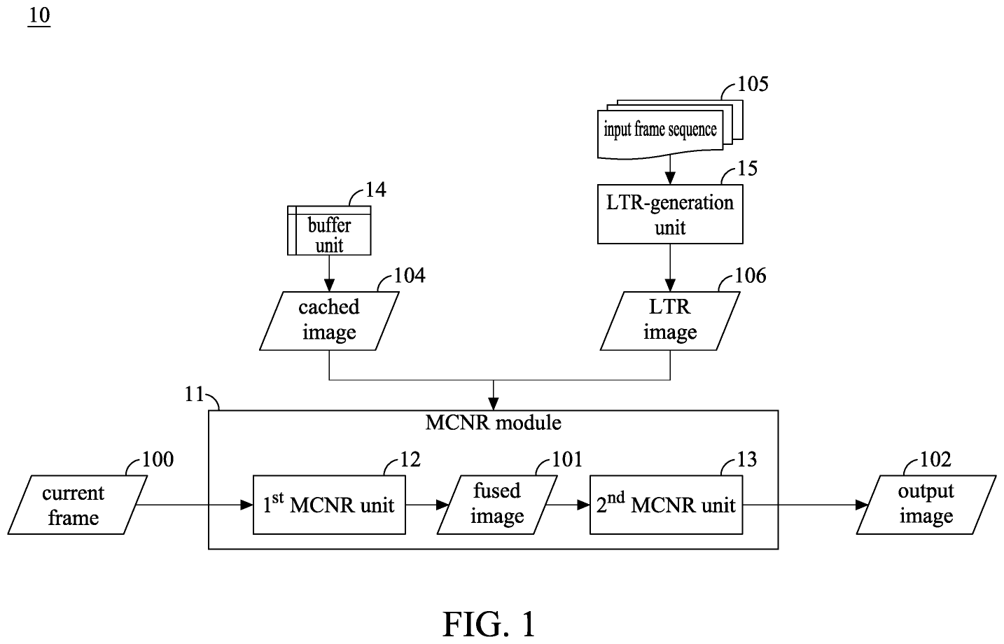

FIG. 1 is a schematic architecture diagram illustrating an image processing device 10, according to an embodiment of the present disclosure. As shown in FIG. 1, the image processing device 10 may include an MCNR module 11, a buffer unit 14, and a long-term reference (LTR)-generation unit 15. The MCNR module 11 may further include the first MCNR unit 12 and the second MCNR unit 13.

The image processing device 10 may be implemented using either general-purpose processing units or special-purpose hardware circuitry. In an embodiment, the image processing device 10 can be a general-purpose processor, a microprocessor, or a microcontroller that loads a program or an instruction set from the electronic device's storage unit (which may include both volatile and non-volatile memories) to carry out the functions of the first MCNR unit 12, the second MCNR unit 13, and the LTR-generation unit 15. In another embodiment, the image processing device 10 may include one or more integrated circuits, such as application-specific integrated circuits (ASICs) and/or field programmable gate arrays (FPGAs), that are dedicated to implementing the first MCNR unit 12, the second MCNR unit 13, and the LTR-generation unit 15.

In an embodiment, the image processing device 10 can be utilized as an essential component in electronic devices, such as cameras and mobile devices that possess photography and imaging capabilities. These electronic devices may consist of an image sensor (though not shown in FIG. 1) in addition to the image processing device 10. The image sensor converts the optical signals received from a variety of lenses into electrical signals, which are then forwarded to the image processing device 10 for further processing. The current frame 100 in FIG. 1 is acquired by the image sensor in the form of the electrical signals, and is sent to the image processing device 10 as one of a sequence of video frames. The current frame 100 is composed of a plurality of pixels, and it serves as the initial input for the image processing device 10. The image processing device 10 processes the current frame 100 using the MCNR module to reduce noise and enhance the overall quality of the image. Additionally, it is worth noting that the current frame 100 may represent the entire current input video frame, or only a certain portion of the current input video frame.

The buffered unit 14 is for storing the cached image 104. The buffered unit 14 can be implemented by a variety of memories, such as dynamic random-access memory (DRAM), static random-access memory (SRAM), flash memory, central processing unit (CPU) Cache, or graphics processing unit (GPU) Cache, but the present disclosure is not limited thereto.

As illustrated in FIG. 1, the current frame 100, after undergoing processing by the MCNR module 11, results in the generation of the output image 102. Therefore, the output image 102 can be understood as an image that has undergone the motion-compensated noise reduction (MCNR) process. It should be appreciated that the output image 102 may not necessarily be the final image presented on the display, as the image processing device 10 may include additional modules to perform other image processing operations, such as color correction, contrast enhancement, or other post-processing techniques that contribute to the refinement of the final displayed image.

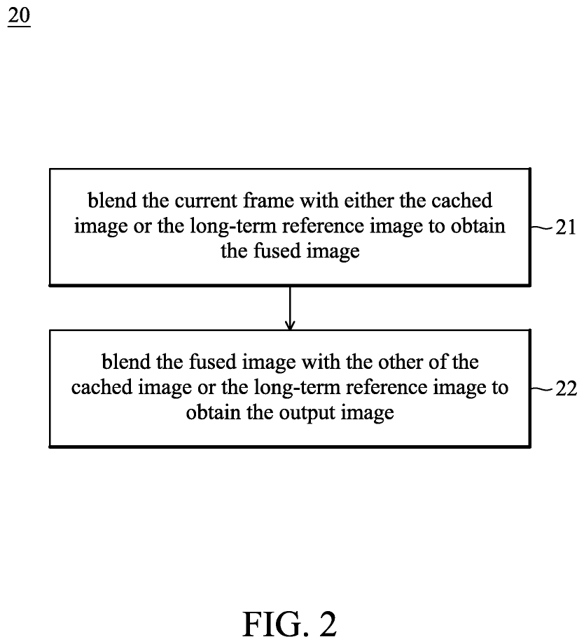

FIG. 2 is a flow diagram illustrating an image processing method 20, according to an embodiment of the present disclosure. As shown in FIG. 2, the image processing method 20 may include the first MCNR stage 21 and the second MCNR stage 22. Since the first MCNR unit 12 and the second MCNR unit 13 illustrated in FIG. 1 are configured to execute the first MCNR stage 21 and the second MCNR stage 22, respectively, please refer to FIG. 1 and FIG. 2 together for a better understanding of the disclosed embodiment.

During the first MCNR stage 21, the first MCNR unit 12 blends the current frame 100 with either the cached image 104 or the long-term reference (LTR) image 106 to obtain the fused image 101. The obtained fused image 101 will then be used as input for the second MCNR unit 13.

The term “blend” or “blending” recited herein refers to the operation of combining two (or more) images into a single composite image, typically by controlling the transparency or intensity of each pixel. In various embodiments of the present disclosure, blending operation can be implemented by various image blending algorithms, such as alpha blending, additive blending, Max and Min blending, Dodge and Burn blending, Poisson blending, or pyramid blending. Unless explicitly specified in the description (for example, implemented as pyramid blending in certain embodiments), the implementation of blending is not limited in the following text.

During the second MCNR stage 22, the second MCNR unit 13 blends the fused image 101 with the other of the cached image 104 or the LTR image 106 to obtain the output image 102. In other words, if the first MCNR unit 12 blends the current frame 100 with the cached image 104 during the first MCNR stage 21, then the second MCNR unit 13 will blend the fused image 101 with the LTR image 106. In contrast, if the first MCNR unit 12 blends the current frame 100 with the LTR image 106 during the first MCNR stage 21, then the second MCNR unit 13 will blend the fused image 101 with the cached image 104.

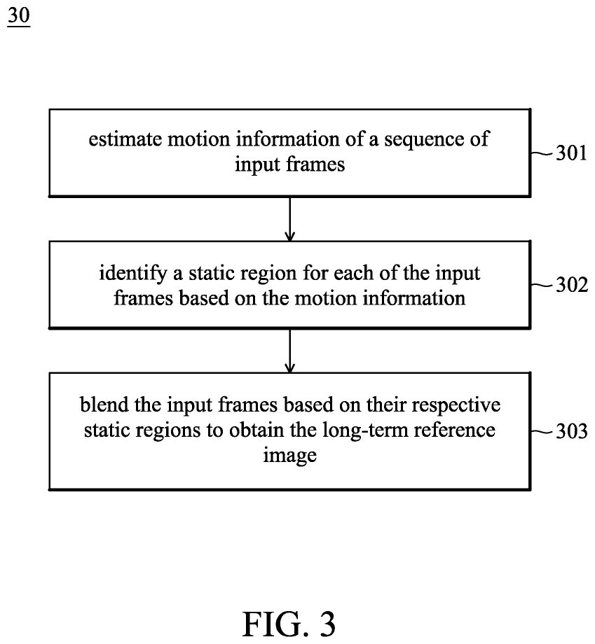

As illustrated in FIG. 1, the cached image 104 is loaded from the buffered unit 14. On the other hand, the LTR image 106 is derived, by the LTR-generation unit 15, from a static region of each input frame in an input frame sequence 105. The derivation for the LTR image 106 can be implemented using a variety of well-established methods, such as Frame Differences, optical flow, or other image differencing techniques. These techniques analyze the pixel-level changes or motion patterns between consecutive frames, helping identify areas that exhibit minimal or no motion over time. In an embodiment, the image processing method may further include an LTR-generation process for deriving the long-term reference image, more details of which will be described with reference to FIG. 3.

FIG. 3 is a flow diagram illustrating the LTR-generation process 30, according to an embodiment of the present disclosure. As illustrated in FIG. 3, the LTR-generation process 30 may include steps 301-303. Since the LTR-generation unit 15 illustrated in FIG. 1 is configured to execute the LTR-generation process 30, please refer to FIG. 1 and FIG. 3 together for a better understanding of the disclosed embodiment.

In step 301, the LTR-generation unit 15 estimates motion information of a sequence of input frames, that is, the input frame sequence 105. This step can be implemented using a variety of well-established motion estimation algorithms, such as block-matching algorithm, phase correlation and frequency domain method, or pixel recursive algorithm, but the present disclosure is not limited thereto.

In step 302, the LTR-generation unit 15 identifies the static region in each of the input frames of the input frame sequence 105 based on the motion information. Further, the identified static region can be marked using various methods, such as binary image labeling, contour labeling, or image overlay, but the present disclosure is not limited thereto. In a typical embodiment, binary image labeling is used for marking the static regions of the input frames, and the result is a binary mask where static regions are marked as one value (e.g., 1) and the rest (i.e., non-static regions) as another value (e.g., 0).

In step 303, the LTR-generation unit 15 blends the input frames based on their respective static regions to obtain the LTR image 106.

It should be noted that the LTR-generation process 30 is not required to execute each time a new incoming input frame is received. Conversely, the LTR-generation process 30 can be scheduled to run at intervals of a certain number of input frames. In other words, the LTR image 106 may be periodically updated, for example, every 10 frames, 20 frames, or 30 frames, without the necessity for an update with every individual input frame. Additionally, the mentioned sequence of input frames may include the current frame or only extend to the input frame immediately preceding the current frame, though the present disclosure is not limited thereto.

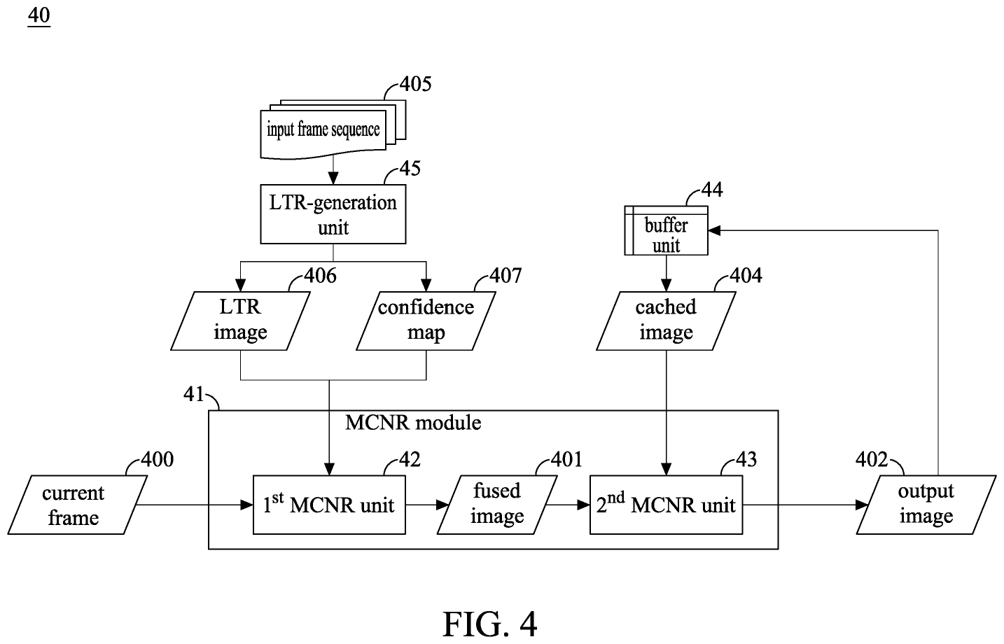

FIG. 4 is a schematic architecture diagram illustrating an image processing device 40, according to an embodiment of the present disclosure. In this embodiment, the LTR image 406 is used for blending during the first MCNR stage, while the cached image 404 is used for blending during the second MCNR stage.

More specifically, during the first MCNR stage, the first MCNR unit 42 blends the current frame 400 with the LTR image 406, which is derived from the input frame sequence 405 by the LTR-generation unit 45, to obtain the fused image 401. Subsequently, during the second MCNR stage, the second MCNR unit 43 blends the fused image 401 with the cached image 404, which is loaded from the buffer unit 44, to obtain the output image 402. Additionally, the obtained output image 402 will be stored in the buffer unit 44 as the cached image 404, which will be used for blending with the succeeding current frame 400.

In a further embodiment, the LTR-generation process executed by the LTR-generation unit 45 further involves generating a confidence map 407 that corresponds to the LTR image 406 based on the motion information of the input frame sequence 405. Additionally, during the first MCNR stage, the first MCNR unit 42 further determines a set of weights for blending each pixel of the current frame 400 with the corresponding pixel of the LTR image 406 based on the confidence map 407. More specifically, the confidence map 407 is composed of the confidence values of each pixel (or each region) in the LTR image 406. A higher confidence value indicates a higher reference value for the pixel (or pixels within that region), allowing it to have a greater weight during blending.

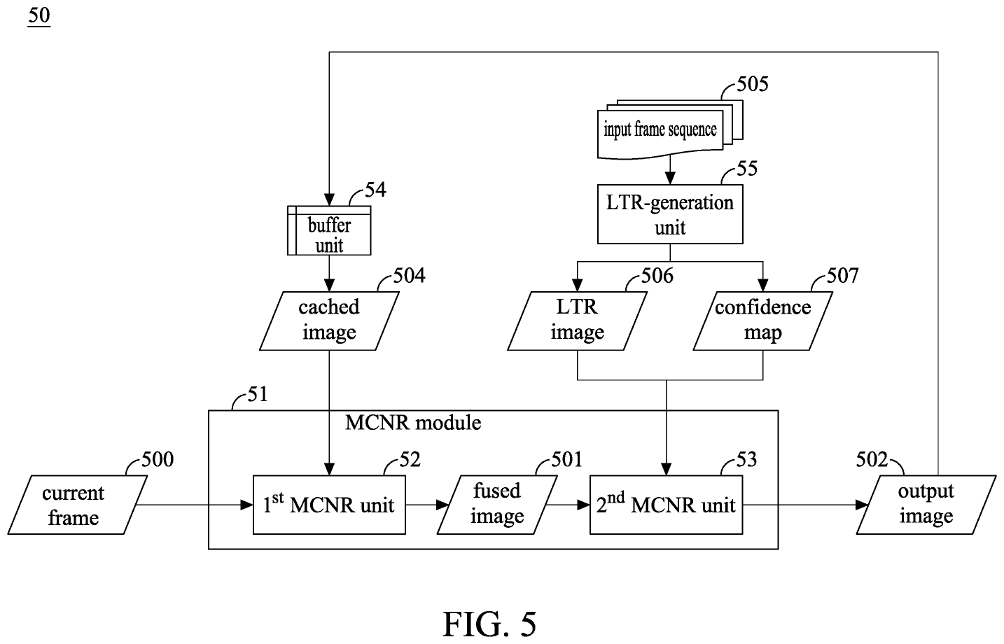

FIG. 5 is a schematic architecture diagram illustrating an image processing device 50, according to another embodiment of the present disclosure. In this embodiment, the cached image 504 is used for blending during the first MCNR stage, while the LTR image 506 is used for blending during the second MCNR stage.

More specifically, during the first MCNR stage, the first MCNR unit 52 blends the current frame 500 with the cached image 504, which is loaded from the buffer unit 54, to obtain the fused image 501. Subsequently, during the second MCNR stage, the second MCNR unit 53 blends the fused image 501 with the LTR image 506, which is derived from the input frame sequence 505 by the LTR-generation unit 55, to obtain the output image 502. Additionally, the obtained output image 502 will be stored in the buffer unit 54 as the cached image 504, which will be used for blending with the succeeding current frame 500.

In a further embodiment, the LTR-generation process executed by the LTR-generation unit 55 further involves generating a confidence map 507 that corresponds to the LTR image 506 based on the motion information of the input frame sequence 505. Additionally, during the second MCNR stage, the second MCNR unit 53 further determines a set of weights for blending each pixel of the fused image 501 with the corresponding pixel of the LTR image 506 based on the confidence map 507. More specifically, the confidence map 507 is composed of the confidence values of each pixel (or each region) in the LTR image 506. A higher confidence value indicates a higher reference value for the pixel (or pixels within that region), allowing it to have a greater weight during blending.

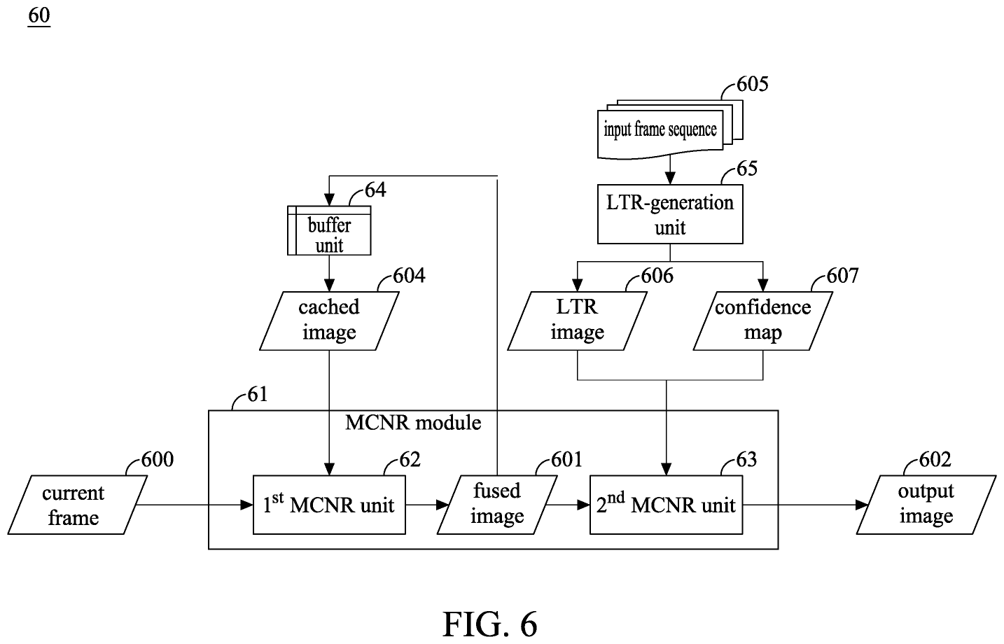

FIG. 6 is a schematic architecture diagram illustrating an image processing device 60, according to another embodiment of the present disclosure. In this embodiment, the cached image 604 is used for blending during the first MCNR stage, while the LTR image 606 is used for blending during the second MCNR stage.

More specifically, during the first MCNR stage, the first MCNR unit 62 blends the current frame 600 with the cached image 604, which is loaded from the buffer unit 64, to obtain the fused image 601. Subsequently, during the second MCNR stage, the second MCNR unit 63 blends the fused image 601 with the LTR image 606, which is derived from the input frame sequence 605 by the LTR-generation unit 65, to obtain the output image 602. Additionally, the fused image 601 obtained in the first MCNR stage will be stored in the buffer unit 64 as the cached image 604, which will be used for blending with the succeeding current frame 600.

In a further embodiment, the LTR-generation process executed by the LTR-generation unit 65 further involves generating a confidence map 607 that corresponds to the LTR image 606 based on the motion information of the input frame sequence 605. Additionally, during the second MCNR stage, the second MCNR unit 63 further determines a set of weights for blending each pixel of the fused image 601 with the corresponding pixel of the LTR image 606 based on the confidence map 607. More specifically, the confidence map 607 is composed of the confidence values of each pixel (or each region) in the LTR image 606. A higher confidence value indicates a higher reference value for the pixel (or pixels within that region), allowing it to have a greater weight during blending.

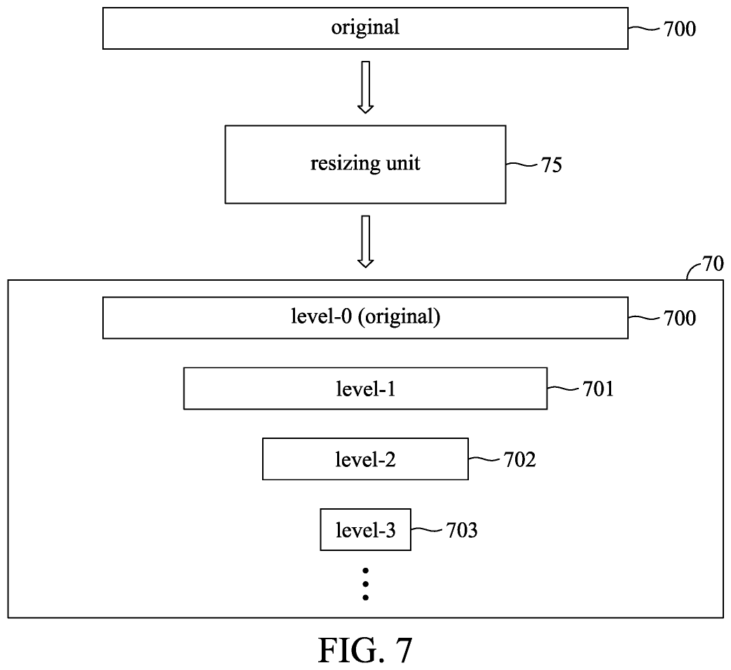

In an embodiment, the image processing device may further include a resizing unit, which is capable of generating a current-frame pyramid, a cached-image pyramid, and an LTR pyramid. More details about the generation of these pyramids will be described with reference to FIG. 7.

FIG. 7 is a schematic diagram illustrating the generation of an image pyramid 70, according to an embodiment of the present disclosure. As shown in FIG. 7, the resizing unit 75 is configured to generate the image pyramid 70 based on the original image 700. The image pyramid 70 is composed of multiple levels of images, including the level-0 image (also the original image) 700, the level-1 image 701, the level-2 image 702, the level-3 image 703, and additional levels (the number of which is not limited in the present disclosure).

The image pyramid 70 serves as a multi-scale representation of the original image 700. Each level of the image pyramid 70 depicts the original image 700 at a different scale. The generation of image pyramid 70 involves an image pyramiding process, which is achieved through a series of smoothing and subsampling operations. More specifically, an appropriate smoothing filter, such as Gaussian smoothing filter or Laplacian smoothing filter, is applied on the original image 700 to reduce high-frequency details and obtain a smoothed or blurred version, representing the low-frequency components. Subsequently, the smoothed or blurred image undergoes subsampling (or downsampling) by selecting every n^{th} pixel along both dimensions. The resulting image, denoted as the level-1 image 701, has reduced dimensions compared to the original image 700 while retaining the low-frequency information. Repeating this process yields subsequent levels, including the level-2 image 702, the level-3 image 703, and lower levels of the image pyramid 70.

It should be appreciated that FIG. 7 illustrates a high-level concept for image pyramiding, which can be applied to any of the abovementioned images, including the current frame, the LTR image, and the cached image, to obtain their respective pyramids. In other words, the resizing unit can be used to generate a current-frame pyramid, a cached-image pyramid, and an LTR pyramid through respectively performing the image pyramiding process on a level-0 current frame, a level-0 cached-image, and a level-0 long-term reference image. Further, the generated current-frame pyramid may include the level-0 current frame, the level-1 current frame, and optionally, the level-2 current frame, as well as additional lower levels. Likewise, the generated cached-image pyramid may include the level-0 cached image, the level-1 cached image, and optionally, the level-2 cached image, as well as additional lower levels. The generated LTR pyramid may include the level-0 LTR image, the level-1 LTR image, and optionally, the level-2 LTR image, as well as additional lower levels. Additionally, it should be noted that, apart from generating the entire image pyramid, the resizing unit can also be configured to execute a resizing process for resizing a specified higher-level image to the scale at a specified lower level.

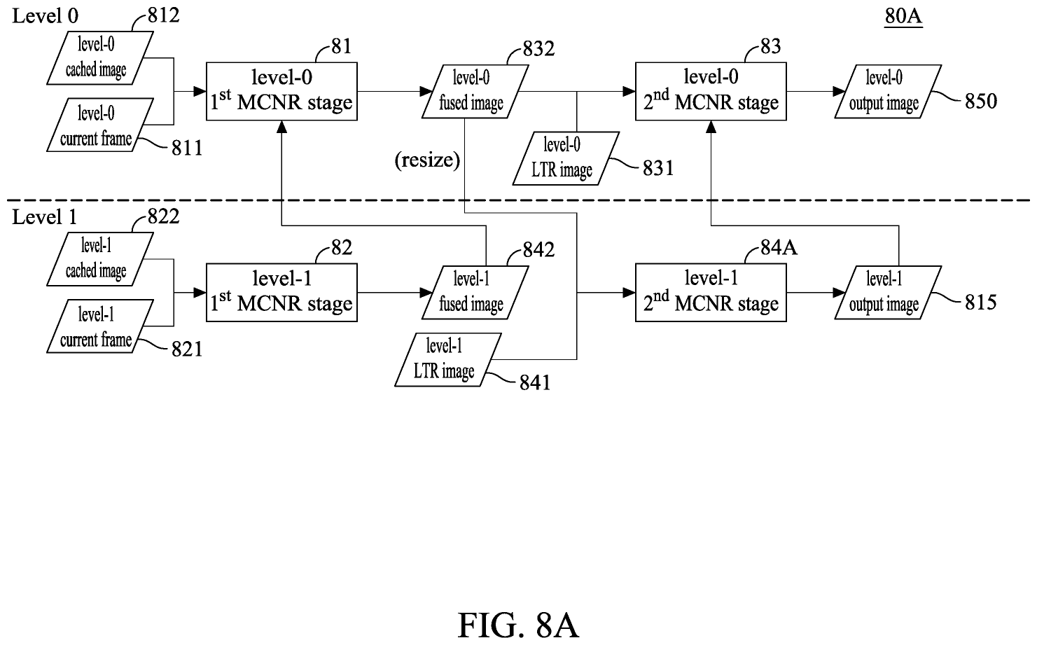

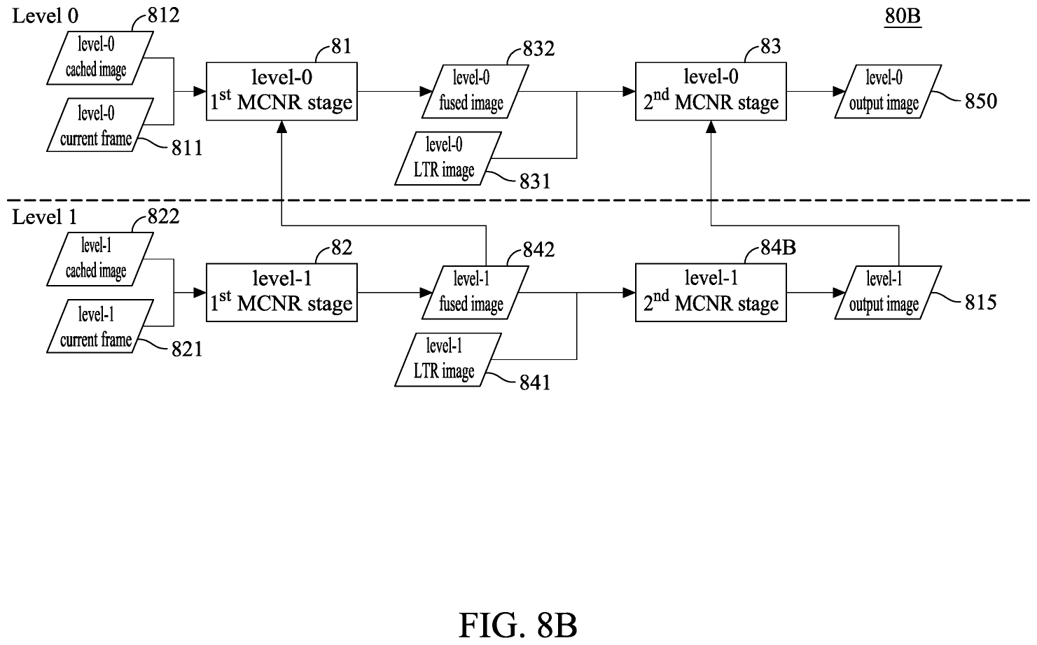

Next, refer to FIG. 8A to FIG. 13B for illustrations of various embodiments of applying the first MCNR stage and the second MCNR stage to the image pyramid architecture. It should be noted that, although only the topmost levels (e.g., level 0 and 1, or levels 0 to 2) of the whole pipeline may be depicted in these figures without illustrating the lower levels, this indicates that the implementation of the lower levels is not limited, instead of implying that the first MCNR stage and the second MCNR stage are not applied to the lower levels.

Furthermore, for a clearer understanding of these embodiments in which the image pyramid architecture is applied, the depicted pipeline at any level of the pyramid structure can be understood as equivalent or analogous to the embodiment illustrated in FIG. 4, FIG. 5 or FIG. 6, except that the blending technique employed in this embodiment is further specified as pyramid blending. Pyramid blending involves an additional reconstruction process based on low-frequency information from lower levels, since the pyramid blending may only target the high-frequency components of the image and may require the incorporation of low-frequency information post-blending, in order to achieve a more comprehensive result that reflects both high and low-frequency components. The reconstruction process may involve restoring the high-frequency image from downsampled or lower-frequency representation, more specifically, combining the high-frequency information obtained from the blending stage with the low-frequency information from lower levels of the pyramid. Additionally, the pyramid blending further involves a resizing process. The resizing process may involve the aforementioned smoothing (e.g., Gaussian smoothing or Laplacian smoothing) and subsampling (or downsampling) procedures to resize the scale of a high-level image to the same scale as a low-level image for blending, but the present disclosure is not limited thereto. In another implementation, the resizing process directly applies subsampling to the high-level image without undergoing a smoothing process.

FIG. 8A is a schematic diagram illustrating an image processing method 80A, according to an embodiment of the present disclosure. As shown in FIG. 8A, the image processing method 80A includes (at least) the level-0 first MCNR stage 81, the level-1 first MCNR stage 82, the level-0 second MCNR stage 83, and the level-1 second MCNR stage 84A. In this embodiment, the level-0 first MCNR stage 81 and the level-1 first MCNR stage 82 are executed by the first MCNR unit, while the level-1 second MCNR stage 84A are executed by the second MCNR unit.

During the level-1 first MCNR stage 82, the first MCNR unit blends the level-1 current frame 821 with the level-1 cached image 822 to obtain the level-1 fused image 842, which is to be used in the reconstruction process of level-0 first MCNR stage 81.

During the level-0 first MCNR stage 81, the first MCNR unit derives the level-0 fused image 832 through blending the level-0 current frame 811 with the level-0 cached image 812 and performing the reconstruction process based on the level-1 fused image 842. Subsequently, the derived level-0 fused image 832 undergoes the aforementioned resizing process executed by the resizing unit, being resized to the scale of Level 1. The resized result is then used in the level-1 second MCNR stage 84A.

During the level-1 second MCNR stage 84A, the second MCNR unit blends the resized result of the level-0 fused image 832 with the level-1 LTR image 841 to obtain the level-1 output image 815, which is to be used in the reconstruction process of level-0 second MCNR stage 83.

During the level-0 second MCNR stage 83, the second MCNR unit generates the level-0 output image 850 through blending the level-0 fused image 832 with the level-0 LTR image 831 and performing the reconstruction process based on the level-1 output image 815.

As a result, the level-0 output image 850 simultaneously encapsulates the high-frequency representation from the level-0 current frame 811, the level-0 cached image 812, and the level-0 LTR image 831, as well as the low-frequency representation (that may provide additional smoothness) from the level-1 fused image 842 and the level-1 output image 815. The comprehensive integration of high and low-frequency components, along with the incorporation of LTR information, ensures that the level-0 output image 850 presents a more refined and complete visual representation than a straightforward blend of input images.

FIG. 8B is a schematic diagram illustrating the image processing method 80B, according to another embodiment of the present disclosure. As depicted, the difference between the image processing methods 80A and 80B lies in the fact that the level-1 second MCNR stage 84A blends the resized result of the level-0 fused image 832 with the level-1 LTR image 841, while the level-1 second MCNR stage 84B uses the level-1 fused image 842 to blend with the level-1 LTR image 841. Other than this difference, FIG. 8B is identical to FIG. 8A in other aspects and will not be further elaborated here.

Compared to the level-1 second MCNR stage 84A, the advantage of the level-1 second MCNR stage 84B lies in directly accessing the level-1 fused image from memory for blending, thereby exempting the computational resources and time required for the resizing process from Level 0 to Level 1.

In an embodiment, the level-1 cached image 822 used in the level-1 first MCNR stage 82 of FIGS. 8A and 8B is obtained through the resizing of the level-0 cached image 812. In other words, the level-0 cached image 812 undergoes the resizing process executed by the resizing unit, resulting in the level-1 cached image 822. In an alternative embodiment, the level-1 output image 815 is stored in the buffer unit as the level-1 cached image 822, subsequently accessed for blending with the succeeding level-1 current frame 821.

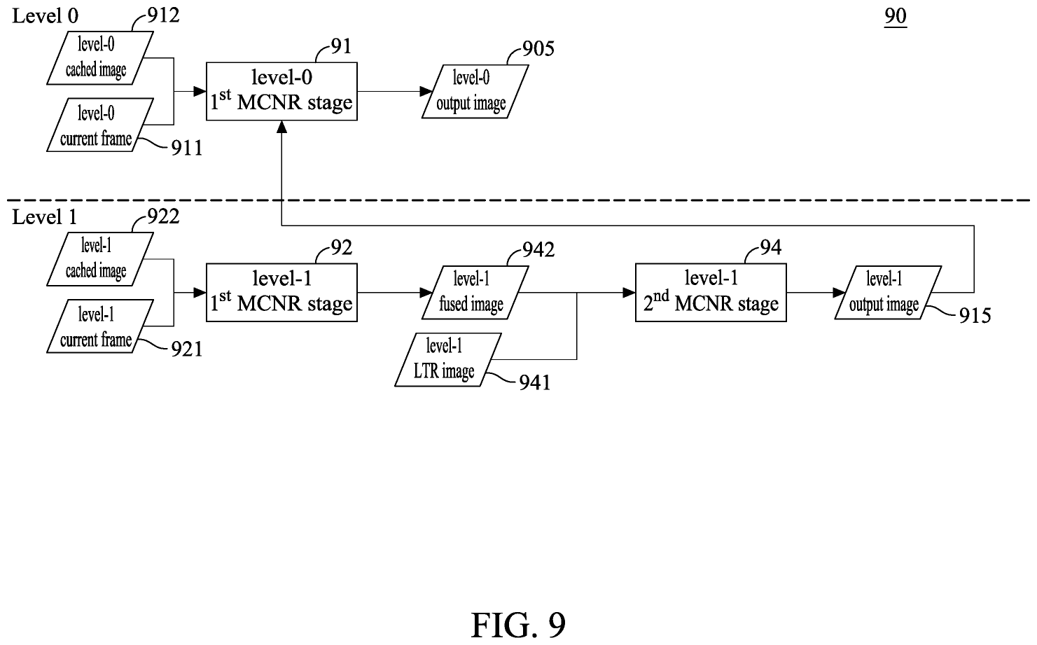

FIG. 9 is a schematic diagram illustrating an image processing method 900, according to another embodiment of the present disclosure. As shown in FIG. 9, the image processing method 90 includes (at least) the level-0 first MCNR stage 91, the level-1 first MCNR stage 92, and the level-1 second MCNR stage 94. In this embodiment, the level-0 first MCNR stage 91 and the level-1 first MCNR stage 92 are executed by the first MCNR unit. On the other hand, the second MCNR unit is configured to execute the level-1 second MCNR stage 94, but not to execute the level-0 second MCNR stage, in contrast to the configuration in the embodiments of FIGS. 8A and 8B.

During the level-1 first MCNR stage 92, the first MCNR unit blends the level-1 current frame 921 with the level-1 cached image 922 to obtain the level-1 fused image 942.

During the level-1 second MCNR stage 94, the second MCNR unit blends the level-1 fused image 942 with the level-1 LTR image 941 to obtain the level-1 output image 915, which is to be used in the reconstruction process of level-0 first MCNR stage 91.

During the level-0 first MCNR stage 91, the first MCNR unit generates the level-0 output image 905 through blending the level-0 current frame 911 with the level-0 cached image 912 and performing the reconstruction process based on the level-1 output image 915.

As a result, the level-0 output image 905 simultaneously encapsulates the high-frequency representation from the level-0 current frame 911 and the level-0 cached image 912, as well as the low-frequency representation (that may provide additional smoothness) from the level-1 output image 915, while LTR information (from level-1 LTR image 941) is taken into account during the generation of the level-1 output image 915. Similar to the level-0 output image 850 depicted in FIGS. 8A and 8B, the comprehensive integration of high and low-frequency components, along with the incorporation of LTR information, ensures that the level-0 output image 905 presents a more refined and complete visual representation than a straightforward blend of input images. But furthermore, in contrast to the level-0 output image 850, the generation of the level-0 output image 905 does not necessitate blending with the LTR image at level-0. Instead, LTR information is indirectly acquired from lower levels through the reconstruction process. This simplified approach allows for a further enhancement in efficiency without excessively compromising image quality.

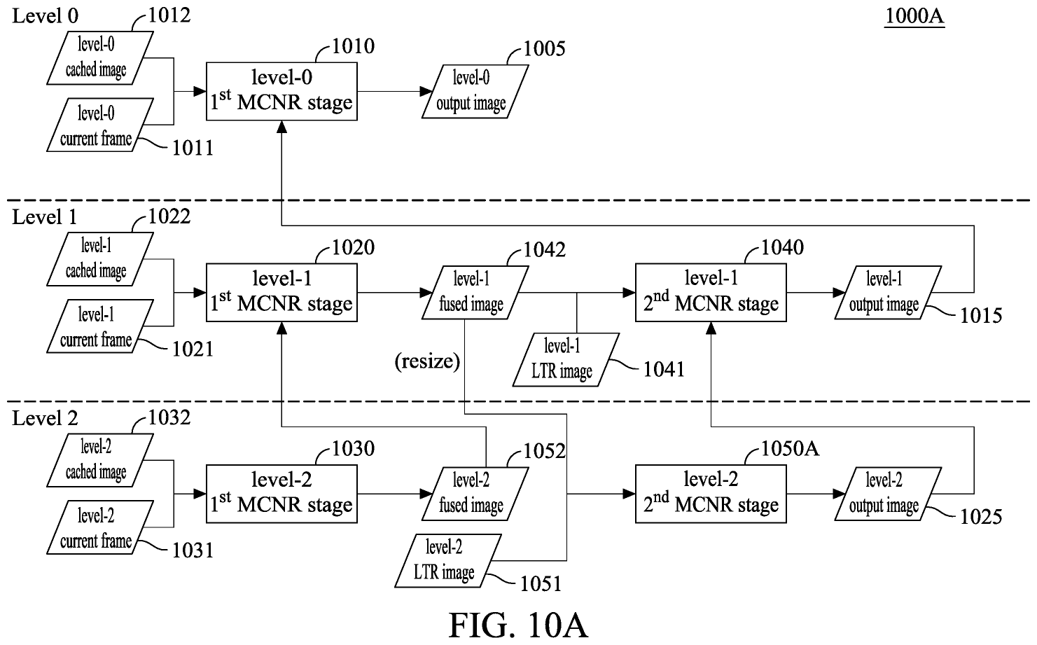

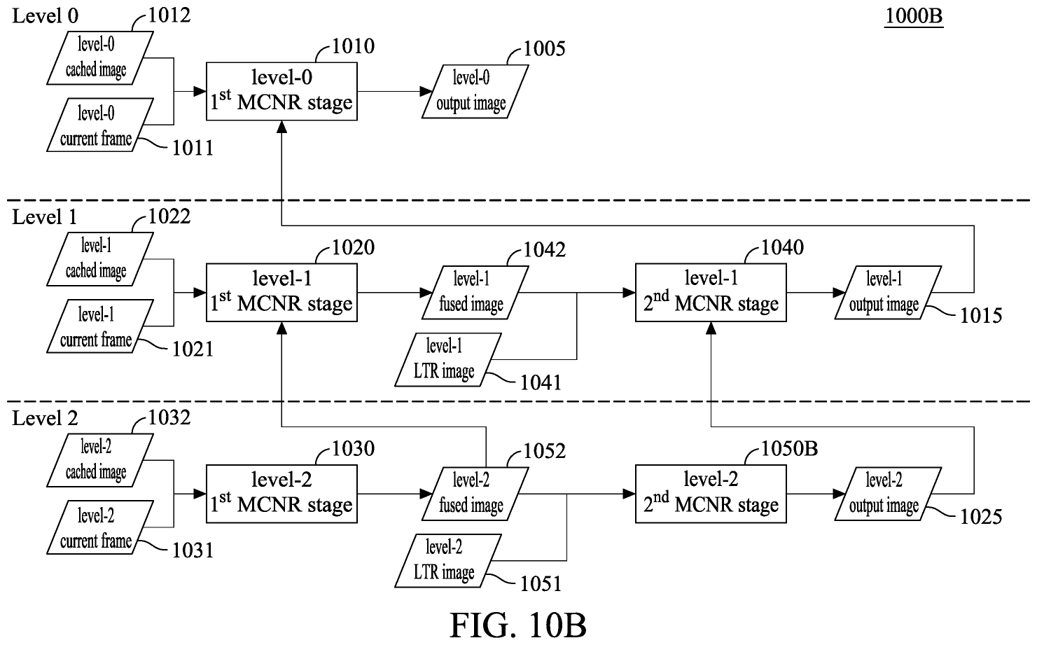

FIG. 10A is a schematic diagram illustrating the image processing method 1000A, according to another embodiment of the present disclosure. As shown in FIG. 10A, the image processing method 1000A includes (at least) the level-0 first MCNR stage 1010, the level-1 first MCNR stage 1020, the level-1 second MCNR stage 1040, the level-2 first MCNR stage 1030, and the level-2 second MCNR stage 1050A. In this embodiment, the level-0 first MCNR stage 1010, the level-1 first MCNR stage 1020, and the level-2 first MCNT stage 1030 are executed by the first MCNR unit, while the level-1 second MCNR stage 1040 and the level-2 second MCNR stage 1050A are executed by the second MCNR unit.

During the level-2 first MCNR stage 1030, the first MCNR unit blends the level-2 current frame 1031 with the level-2 cached image 1032 to obtain the level-2 fused image 1052, which is to be used in the reconstruction process of level-1 first MCNR stage 1020.

During the level-1 first MCNR stage 1020, the first MCNR unit derives the level-1 fused image 1042 through blending the level-1 current frame 1021 with the level-1 cached image 1022 and performing the reconstruction process based on the level-2 fused image 1052. Subsequently, the derived level-1 fused image 1042 undergoes the aforementioned resizing process executed by the resizing unit, being resized to the scale of Level 2. The resized result is then used in the level-2 second MCNR stage 1050A.

During the level-2 second MCNR stage 1050A, the second MCNR unit blends the resized result of the level-1 fused image 1042 with the level-2 LTR image 1051 to obtain the level-2 output image 1025, which is to be used in the reconstruction process of level-1 second MCNR stage 1040.

During the level-1 second MCNR stage 1040, the second MCNR unit derives the level-1 output image 1015 through blending the level-1 fused image 1042 with the level-1 LTR image 1041 and performing the reconstruction process based on the level-2 output image 1025. The level-1 output image 1015 is then used in the reconstruction process of the level-0 first MCNR stage 1010.

During the level-0 first MCNR stage 1010, the first MCNR unit generates the level-0 output image 1005 through blending the level-0 current frame 1011 with the level-0 cached image 1012 and performing the reconstruction process based on the level-1 output image 1015.

Compared to the illustrated embodiment of FIG. 9, the level-0 output image 1005 further incorporates additional information from the lower level(s) of the pyramid, including the level-2 current frame 1031, the level-2 cached image 1032, the level-2 LTR image 1051, and the level-2 fused image 1052, and thus may present even more refined visual representation than the level-0 output image 905.

FIG. 10B is a schematic diagram illustrating the image processing method 1000B, according to another embodiment of the present disclosure. As depicted, the difference between the image processing methods 1000A and 1000B lies in the fact that the level-2 second MCNR stage 1050A blends the resized result of the level-1 fused image 1042 with the level-2 LTR image 1051, while the level-2 second MCNR stage 1050B uses the level-2 fused image 1052 to blend with the level-2 LTR image 1051. Other than this difference, FIG. 10B is identical to FIG. 10A in other aspects and will not be further elaborated here.

Compared to the level-2 second MCNR stage 1050A, the advantage of the level-2 second MCNR stage 1050B lies in directly accessing the level-2 fused image from memory for blending, thereby exempting the computational resources and time required for the resizing process from Level 1 to Level 2.

In an embodiment, the level-2 cached image 1032 used in the level-2 first MCNR stage 1030 of FIGS. 10A and 10B is obtained through the resizing of the level-1 cached image 1022. In other words, the level-1 cached image 1022 undergoes the resizing process executed by the resizing unit, resulting in the level-2 cached image 1032. In an alternative embodiment, the level-2 output image 1025 is stored in the buffer unit as the level-2 cached image 1032, subsequently accessed for blending with the succeeding level-2 current frame 1031.

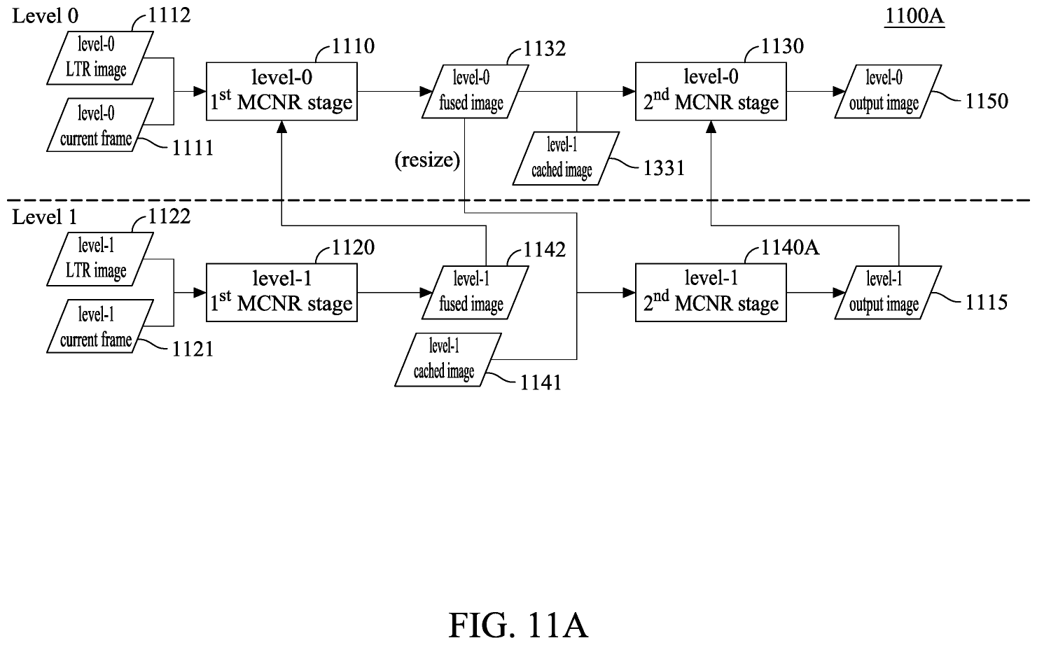

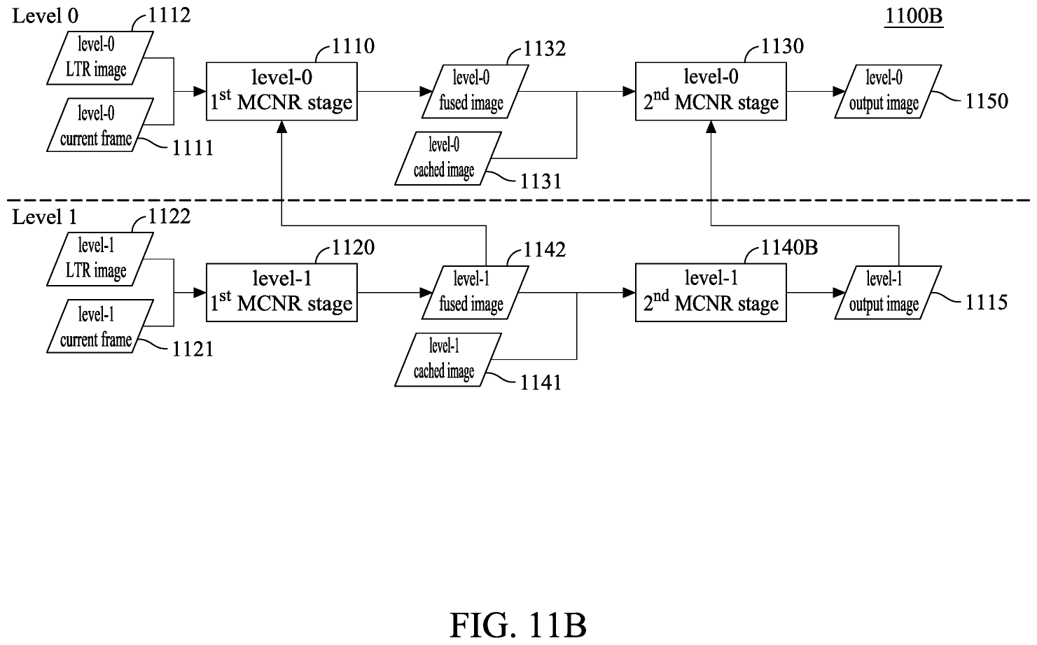

FIG. 11A is a schematic diagram illustrating an image processing method 800, according to another embodiment of the present disclosure. As shown in FIG. 11A, the image processing method 1100A includes (at least) the level-0 first MCNR stage 1110, the level-1 first MCNR stage 1120, the level-0 second MCNR stage 1130, and the level-1 second MCNR stage 1140A. In this embodiment, the level-0 first MCNR stage 1110 and the level-1 first MCNR stage 1120 are executed by the first MCNR unit, while the level-1 second MCNR stage 1140A are executed by the second MCNR unit.

During the level-1 first MCNR stage 1120, the first MCNR unit blends the level-1 current frame 1121 with the level-1 LTR image 1122 to obtain the level-1 fused image 1142, which is to be used in the reconstruction process of level-0 first MCNR stage 1110.

During the level-0 first MCNR stage 1110, the first MCNR unit derives the level-0 fused image 1132 through blending the level-0 current frame 1111 with the level-0 LTR image 1112 and performing the reconstruction process based on the level-1 fused image 1142. Subsequently, the derived level-0 fused image 1132 undergoes the resizing process executed by the resizing unit, being resized to the scale of Level 1. The resized result is then used in the level-1 second MCNR stage 1140A.

During the level-1 second MCNR stage 1140A, the second MCNR unit blends the resized result of the level-0 fused image 1132 with the level-1 cached image 1141 to obtain the level-1 output image 1115, which is to be used in the reconstruction process of level-0 second MCNR stage 1130.

During the level-0 second MCNR stage 1130, the second MCNR unit generates the level-0 output image 1150 through blending the level-0 fused image 1132 with the level-0 cached image 1131 and performing the reconstruction process based on the level-1 output image 1115.

As a result, the level-0 output image 1150 simultaneously encapsulates the high-frequency representation from the level-0 current frame 1111, the level-0 cached image 1112, and the level-0 LTR image 1131, as well as the low-frequency representation (that may provide additional smoothness) from the level-1 fused image 1142 and the level-1 output image 1115. The comprehensive integration of high and low-frequency components, along with the incorporation of LTR information, ensures that the level-0 output image 1150 presents a more refined and complete visual representation than a straightforward blend of input images.

FIG. 11B is a schematic diagram illustrating the image processing method 1100B, according to another embodiment of the present disclosure. As depicted, the difference between the image processing methods 1100A and 1100B lies in the fact that the level-1 second MCNR stage 1140A blends the resized result of the level-0 fused image 1132 with the level-1 cached image 1141, while the level-1 second MCNR stage 1140B uses the level-1 fused image 1142 to blend with the level-1 cached image 1141. Other than this difference, FIG. 11B is identical to FIG. 11A in other aspects and will not be further elaborated here.

Compared to the level-1 second MCNR stage 1140A, the advantage of the level-1 second MCNR stage 1140B lies in directly accessing the level-1 fused image from memory for blending, thereby exempting the computational resources and time required for the resizing process from Level 0 to Level 1.

In an embodiment, the level-1 cached image 1141 used in the level-1 second MCNR stage 1140A or 1140B is obtained through the resizing of the level-0 cached image 1131. In other words, the level-0 cached image 1131 undergoes the resizing process executed by the resizing unit, resulting in the level-1 cached image 1141. In an alternative embodiment, the level-1 output image 1115 is stored in the buffer unit as the level-1 cached image 1141, subsequently accessed for blending with the succeeding level-1 fused image 1142.

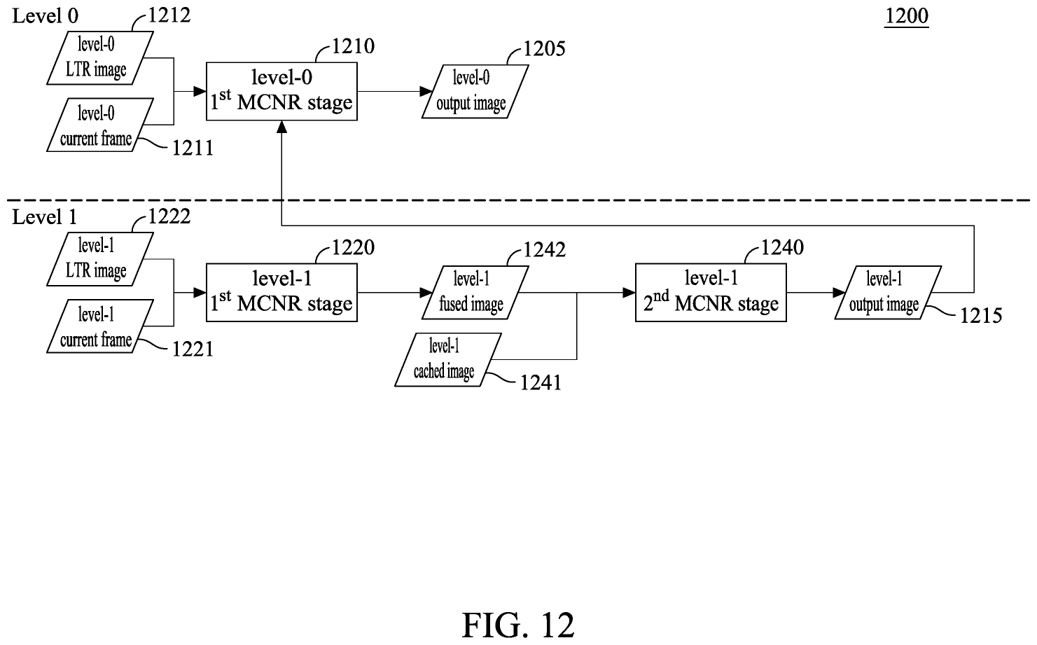

FIG. 12 is a schematic diagram illustrating an image processing method 1200, according to another embodiment of the present disclosure. As shown in FIG. 12, the image processing method 1200 includes (at least) the level-0 first MCNR stage 1210, the level-1 first MCNR stage 1220, and the level-1 second MCNR stage 1240. In this embodiment, the level-0 first MCNR stage 1210 and the level-1 first MCNR stage 1220 are executed by the first MCNR unit. On the other hand, the second MCNR unit is configured to execute the level-1 second MCNR stage 1240, but not to execute the level-0 second MCNR stage, in contrast to the configuration in the embodiments of FIGS. 11A and 11B.

During the level-1 first MCNR stage 1220, the first MCNR unit blends the level-1 current frame 1221 with the level-1 LTR image 1222 to obtain the level-1 fused image 1242.

During the level-1 second MCNR stage 1240, the second MCNR unit blends the level-1 fused image 1242 with the level-1 cached image 1241 to obtain the level-1 output image 1215, which is to be used in the reconstruction process of level-0 first MCNR stage 1210.

During the level-0 first MCNR stage 1210, the first MCNR unit generates the level-0 output image 1205 through blending the level-0 current frame 1211 with the level-0 LTR image 1212 and performing the reconstruction process based on the level-1 output image 1215.

As a result, the level-0 output image 1205 simultaneously encapsulates the high-frequency representation from the level-0 current frame 1211 and the level-0 LTR image 1212, as well as the low-frequency representation (that may provide additional smoothness) from the level-1 output image 1215, while the cached image 1241 is taken into account during the generation of the level-1 output image 1215. Similar to the level-0 output image 1150 depicted in FIGS. 11A and 11B, the comprehensive integration of high and low-frequency components ensures that the level-0 output image 1205 presents a more refined and complete visual representation than a straightforward blend of input images. But furthermore, in contrast to the level-0 output image 1150, the generation of the level-0 output image 1205 does not necessitate blending with the cached image at level-0. Instead, information contained in the cached image is indirectly acquired from lower levels through the reconstruction process. This simplified approach allows for a further enhancement in efficiency without excessively compromising image quality.

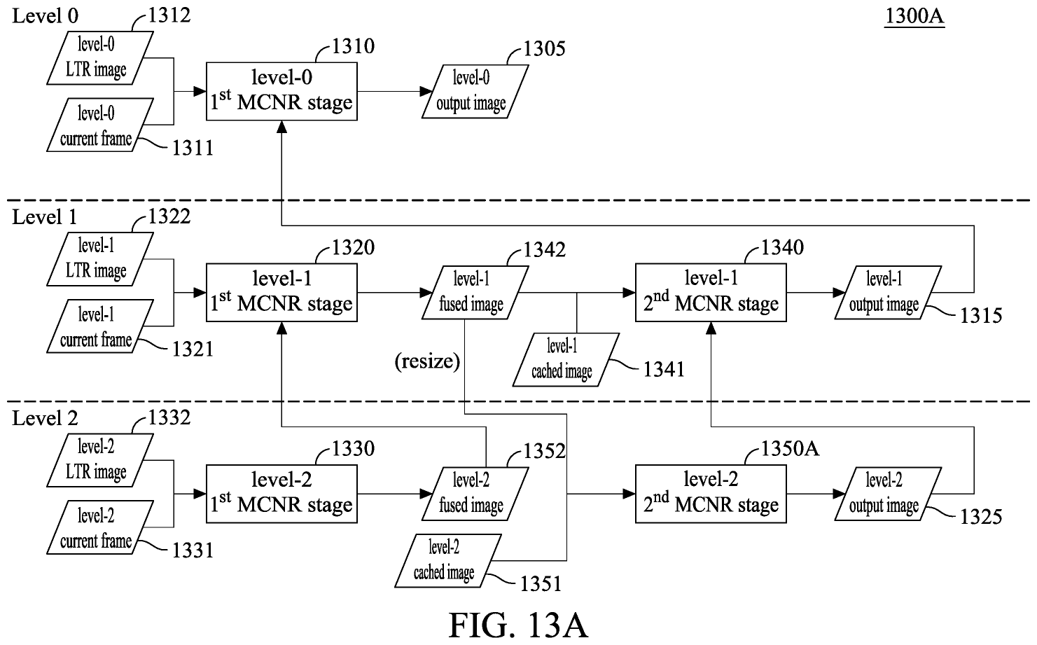

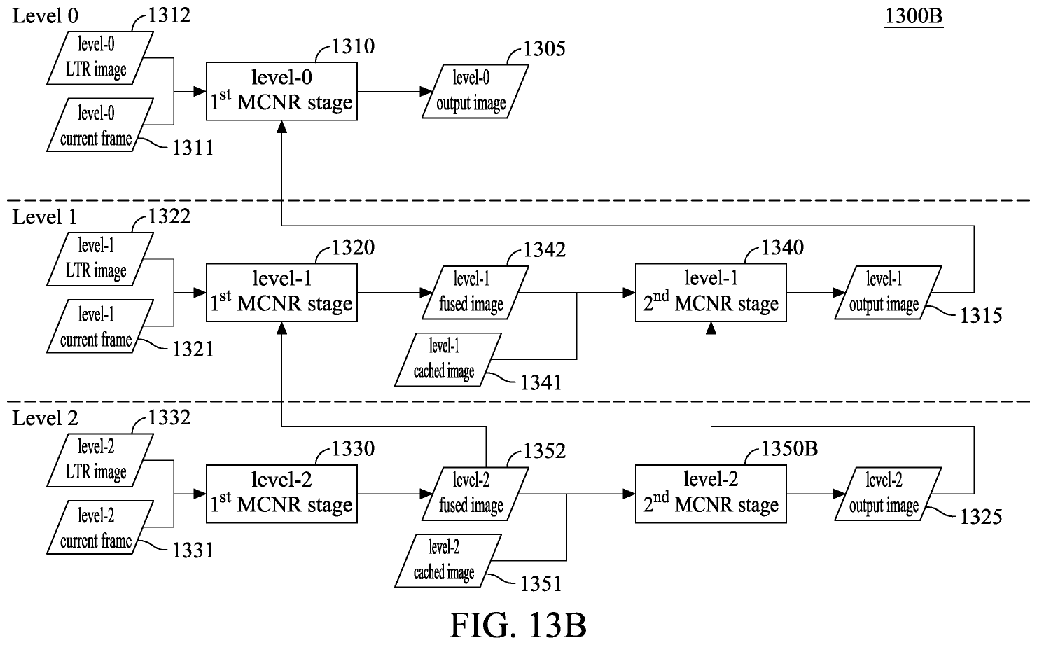

FIG. 13A is a schematic diagram illustrating the image processing method 1300A, according to another embodiment of the present disclosure. As shown in FIG. 13A, the image processing method 1300A includes (at least) the level-0 first MCNR stage 1310, the level-1 first MCNR stage 1320, the level-1 second MCNR stage 1340, the level-2 first MCNR stage 1330, and the level-2 second MCNR stage 1350A. In this embodiment, the level-0 first MCNR stage 1310, the level-1 first MCNR stage 1320, and the level-2 first MCNT stage 1330 are executed by the first MCNR unit, while the level-1 second MCNR stage 1340 and the level-2 second MCNR stage 1350A are executed by the second MCNR unit.

During the level-2 first MCNR stage 1330, the first MCNR unit blends the level-2 current frame 1331 with the level-2 LTR image 1332 to obtain the level-2 fused image 1352, which is to be used in the reconstruction process of level-1 first MCNR stage 1320.

During the level-1 first MCNR stage 1320, the first MCNR unit derives the level-1 fused image 1342 through blending the level-1 current frame 1321 with the level-1 LTR image 1322 and performing the reconstruction process based on the level-2 fused image 1352. Subsequently, the derived level-1 fused image 1342 undergoes the resizing process executed by the resizing unit, being resized to the scale of Level 2. The resized result is then used in the level-2 second MCNR stage 1350A.

During the level-2 second MCNR stage 1350A, the second MCNR unit blends the resized result of the level-1 fused image 1342 with the level-2 cached image 1351 to obtain the level-2 output image 1325, which is to be used in the reconstruction process of level-1 second MCNR stage 1340.

During the level-1 second MCNR stage 1340, the second MCNR unit derives the level-1 output image 1315 through blending the level-1 fused image 1342 with the level-1 cached image 1341 and performing the reconstruction process based on the level-2 output image 1325. The level-1 output image 1315 is then used in the reconstruction process of the level-0 first MCNR stage 1310.

During the level-0 first MCNR stage 1310, the first MCNR unit generates the level-0 output image 1305 through blending the level-0 current frame 1311 with the level-0 LTR image 1312 and performing the reconstruction process based on the level-1 output image 1315.

Compared to the illustrated embodiment of FIG. 12, the level-0 output image 1305 further incorporates additional information from the lower level(s) of the pyramid, including the level-2 current frame 1331, the level-2 LTR image 1332, the level-2 cached image 1351, and the level-2 fused image 1352, and thus may present even more refined visual representation than the level-0 output image 1205.

FIG. 13B is a schematic diagram illustrating the image processing method 1300B, according to another embodiment of the present disclosure. As depicted, the difference between the image processing methods 1300A and 1300B lies in the fact that the level-2 second MCNR stage 1350A blends the resized result of the level-1 fused image 1342 with the level-2 cached image 1351, while the level-2 second MCNR stage 1350B uses the level-2 fused image 1352 to blend with the level-2 cached image 1351. Other than this difference, FIG. 13B is identical to FIG. 13A in other aspects and will not be further elaborated here.

Compared to the level-2 second MCNR stage 1350A, the advantage of the level-2 second MCNR stage 1350B lies in directly accessing the level-2 fused image from memory for blending, thereby exempting the computational resources and time required for the resizing process from Level 1 to Level 2.

In an embodiment, the level-2 cached image 1351 used in the level-2 second MCNR stage 1350A or 1350B is obtained through the resizing of the level-1 cached image 1341. In other words, the level-1 cached image 1341 undergoes the resizing process executed by the resizing unit, resulting in the level-2 cached image 1351. In an alternative embodiment, the level-2 output image 1325 is stored in the buffer unit as the level-2 cached image 1351, subsequently accessed for blending with the succeeding level-2 fused image 1352.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing method, comprising:
a first MCNR stage, including blending a current frame with either a cached image or a long-term reference image to obtain a fused image, wherein the cached image is loaded from a buffer unit, and the long-term reference image is derived from a static region of each input frame in a sequence of input frames; and
a second MCNR stage, including blending the fused image with the other of the cached image or the long-term reference image to obtain an output image.

2. The method as claimed in claim 1, further comprising an LTR-generation process for deriving the long-term reference image, wherein the LTR-generation process comprises:
estimating motion information of multiple input frames in the sequence of input frames;
identifying the static region in each of the input frames based on the motion information; and
blending the input frames based on their respective static regions to obtain the long-term reference image.

3. The method as claimed in claim 2, wherein the LTR-generation process further includes generating a confidence map that corresponds to the long-term reference image based on the motion information of the sequence of input frames;
wherein the first MCNR stage further includes determining a set of weights for blending each pixel of the current frame with a corresponding pixel of the long-term reference image based on the confidence map.

4. The method as claimed in claim 1, wherein the first MCNR stage further includes blending the current frame with the long-term reference image to obtain the fused image; and
wherein the second MCNR stage further includes blending the fused image with the cached image to obtain the output image; and
wherein the obtained output image is stored in the buffer unit as the cached image.

5. The method as claimed in claim 4, further comprising:
resizing a level-0 current frame to obtain a level-1 current frame, and resizing a level-0 long-term reference image to obtain a level-1 long-term reference image;
a level-1 first MCNR stage, including blending the level-1 current frame with the level-1 long-term reference image to obtain a level-1 fused image;
a level-0 first MCNR stage, including deriving a level-0 fused image through blending the level-0 current frame with the level-0 long-term reference image and performing a reconstruction process based on the level-1 fused image;
resizing the level-0 fused image;
a level-1 second MCNR stage, including blending the resized level-0 fused image with a level-1 cached image to obtain a level-1 output image; and
a level-0 second MCNR stage, including deriving a level-0 output image through blending the level-0 fused image with the level-0 cached image and performing the reconstruction process based on the level-1 output image;
wherein said first MCNR stage is the level-0 first MCNR stage, said second MCNR stage is the level-0 second MCNR stage, said current frame is the level-0 current frame, said cached image is the level-0 cached image, said long-term reference image is the level-0 long-term reference image, said fused image is the level-0 fused image, and said output image is the level-0 output image.

6. The method as claimed in claim 5, wherein the level-1 output image is obtained either by resizing the level-0 cached image or by accessing the level-1 output image from the buffer unit.

7. The method as claimed in claim 4, further comprising:
resizing a level-0 current frame to obtain a level-1 current frame, and resizing a level-0 long-term reference image to obtain a level-1 long-term reference image;
a level-1 first MCNR stage, including blending the level-1 current frame with the level-1 long-term reference image to obtain a level-1 fused image;
a level-0 first MCNR stage, including deriving a level-0 fused image through blending the level-0 current frame with the level-0 long-term reference image and performing a reconstruction process based on the level-1 fused image;
a level-1 second MCNR stage, including blending the level-1 fused image with a level-1 cached image to obtain a level-1 output image; and
a level-0 second MCNR stage, including deriving a level-0 output image through blending the level-0 fused image with the level-0 cached image and performing the reconstruction process based on the level-1 output image;
wherein said first MCNR stage is the level-0 first MCNR stage, said second MCNR stage is the level-0 second MCNR stage, said current frame is the level-0 current frame, said cached image is the level-0 cached image, said long-term reference image is the level-0 long-term reference image, said fused image is the level-0 fused image, and said output image is the level-0 output image.

8. The method as claimed in claim 4, further comprising:
resizing a level-0 current frame to obtain a level-1 current frame, and resizing a level-0 long-term reference image to obtain a level-1 long-term reference image;
a level-1 first MCNR stage, including blending the level-1 current frame with the level-1 long-term reference image to obtain a level-1 fused image;
a level-1 second MCNR stage, including blending the level-1 fused image with a level-1 cached image to obtain a level-1 output image; and
a level-0 first MCNR stage, including deriving a level-0 output image through blending the level-0 current frame with the level-0 long-term reference image and performing a reconstruction process based on the level-1 output image;
wherein said first MCNR stage is the level-1 first MCNR stage, said second MCNR stage is the level-1 second MCNR stage, said current frame is the level-1 current frame, said cached image is the level-1 cached image, said long-term reference image is the level-1 long-term reference image, said fused image is the level-1 fused image, and said output image is the level-1 output image.

9. The method as claimed in claim 8, further comprising:
resizing a level-0 current frame to obtain a level-2 current frame, and resizing a level-0 long-term reference image to obtain a level-2 long-term reference image;
a level-2 first MCNR stage, including blending the level-2 current frame with the level-2 long-term reference image to obtain a level-2 fused image;
resizing the level-1 fused image; and
a level-2 second MCNR stage, including blending the resized level-1 fused image with a level-2 cached image to obtain a level-2 output image;
wherein the level-1 first MCNR stage further includes deriving the level-1 fused image through blending the level-1 current frame with the level-1 long-term reference image and performing the reconstruction process based on the level-2 fused image, and the level-1 second MCNR stage further includes deriving the level-1 output image through blending the level-1 fused image with the level-1 cached image and performing the reconstruction process based on the level-2 output image.

10. The method as claimed in claim 8, further comprising:
resizing a level-0 current frame to obtain a level-2 current frame, and resizing a level-0 long-term reference image to obtain a level-2 long-term reference image;
a level-2 first MCNR stage, including blending the level-2 current frame with the level-2 long-term reference image to obtain a level-2 fused image; and
a level-2 second MCNR stage, including blending the level-2 fused image with a level-2 cached image to obtain a level-2 output image;
wherein the level-1 first MCNR stage further includes deriving the level-1 fused image through blending the level-1 current frame with the level-1 long-term reference image and performing the reconstruction process based on the level-2 fused image, and the level-1 second MCNR stage further includes deriving the level-1 output image through blending the level-1 fused image with the level-1 cached image and performing the reconstruction process based on the level-2 output image.

11. The method as claimed in claim 1, wherein the first MCNR stage further includes blending the current frame with the cached image to obtain the fused image; and
wherein the second MCNR stage further includes blending the fused image with the long-term reference image to obtain the output image; and
wherein either the obtained output image or the fused image is stored in the buffer unit as the cached image.

12. The method as claimed in claim 1, wherein the first MCNR stage and the second MCNR stage are applied to an image pyramid architecture.

13. An image processing device, comprising:
a buffer unit, for storing a cached image;
a first MCNR unit, configured to blend a current frame with either the cached image or a long-term reference image to obtain a fused image, wherein the cached image is loaded from the buffer unit, and the long-term reference image is derived from a static region of each input frame in a sequence of input frames; and
a second MCNR unit, configured to blend the fused image with the other of the cached image or the long-term reference image to obtain an output image.

14. The image processing device as claimed in claim 13, further comprising:
an LTR-generation unit, configured to estimate motion information of multiple input frames in the sequence of input frames, identify the static region in each of the input frames based on the motion information, and blend the input frames based on their respective static regions to obtain the long-term reference image.

15. The image processing device as claimed in claim 14, wherein the LTR-generation unit is further configured to generate a confidence map that corresponds to the long-term reference image based on the motion information of the sequence of input frames;
wherein the first MCNR unit is further configured to determine a set of weights for blending each pixel of the current frame with a corresponding pixel of the long-term reference image based on the confidence map.

16. The image processing device as claimed in claim 13, wherein the first MCNR unit is further configured to blend the current frame with the long-term reference image to obtain the fused image; and
wherein the second MCNR unit is further configured to blend the fused image with the cached image to obtain the output image;
wherein the obtained output image is stored in the buffer unit as the cached image.

17. The image processing device as claimed in claim 16, further comprising:
a resizing unit, configured to resize a level-0 current frame to obtain a level-1 current frame, and resize a level-0 long-term reference image to obtain a level-1 long-term reference image;
wherein the first MCNR unit is further configured to blend the level-1 current frame with the level-1 long-term reference image to obtain a level-1 fused image;
wherein the first MCNR unit is further configured to derive a level-0 fused image through blending the level-0 current frame with the level-0 long-term reference image and performing a reconstruction process based on the level-1 fused image;
wherein the second MCNR unit is further configured to blend the level-1 fused image with a level-1 cached image to obtain a level-1 output image;
wherein the second MCNR unit is further configured to derive a level-0 output image through blending the level-0 fused image with the level-0 cached image and performing the reconstruction process based on the level-1 output image; and
wherein said current frame is the level-0 current frame, said cached image is the level-0 cached image, said long-term reference image is the level-0 long-term reference image, said fused image is the level-0 fused image, and said output image is the level-0 output image.

18. The image processing device as claimed in claim 16, further comprising:
a resizing unit, configured to resize a level-0 current frame to obtain a level-1 current frame, and resize a level-0 long-term reference image to obtain a level-1 long-term reference image;
wherein the first MCNR unit is further configured to blend the level-1 current frame with the level-1 long-term reference image to obtain a level-1 fused image;
wherein the second MCNR unit is further configured to blend the level-1 fused image with a level-1 cached image to obtain a level-1 output image;
wherein the first MCNR unit is further configured to derive a level-0 output image through blending the level-0 current frame with the level-0 long-term reference image and performing a reconstruction process based on the level-1 output image; and
wherein said current frame is the level-1 current frame, said cached image is the level-1 cached image, said long-term reference image is the level-1 long-term reference image, said fused image is the level-1 fused image, and said output image is the level-1 output image.

19. The image processing device as claimed in claim 13, wherein the first MCNR unit is further configured to blend the current frame with the cached image to obtain the fused image; and
wherein the second MCNR unit is further configured to blend the fused image with the long-term reference image to obtain the output image; and
wherein either the obtained output image or the fused image is stored in the buffer unit as the cached image.

20. The image processing device as claimed in claim 13, wherein the first MCNR unit and the second MCNR unit are applied to an image pyramid architecture.
